(19) United States
(12) Patent Application Publication
(10) Pub. No.: US 2017/0032511 A1
(43) Pub. Date: Feb. 2, 2017

(54) LIGHT SOURCE DEVICE AND ALIGNMENT MARK SHOOTING AND RECOGNIZING SYSTEM

(71) Applicants: BOE TECHNOLOGY GROUP CO., LTD., Beijing (CN); HEFEI XINSHENG OPTOELECTRONICS TECHNOLOGY CO., LTD., Anhui (CN)

(72) Inventors: Wenhao WANG, Beijing (CN); Yanping HONG, Beijing (CN); Yan WANG, Beijing (CN); Baojie DONG, Beijing (CN); Haibo XU, Beijing (CN)

(73) Assignees: BOE TECHNOLOGY GROUP CO., LTD., Beijing (CN); HEFEI XINSHENG OPTOELECTRONICS TECHNOLOGY CO., LTD., Anhui (CN)

(21) Appl. No.: 14/911,209

(22) PCT Filed: Aug. 10, 2015
(86) PCT No.: PCT/CN2015/086500

§ 371 Date: Feb. 9, 2016

(30) Foreign Application Priority Data
Mar. 31, 2015 (CN) 201510149687.X

(51) Int. Cl. G06T 7/00; F21V 7/05; F21V 3/00

(52) U.S. Cl. CPC G06T 7/0004; F21V 3/00; F21V 7/05; F21Y 2115/10

(57) ABSTRACT

A light source device includes a case defining an accommodation space. The case includes a light transmissible surface and a locating-mounting hole. The locating-mounting hole defines a projection through space within the accommodation space in an axial direction of the locating-mounting hole. The light source device further includes a plurality of light emitting sources arranged within the accommodation space and surrounding the projection through space. The light emitting sources are configured for emitting light towards the light transmissible surface.

### CROSS REFERENCE OF RELATED APPLICATION

The present application claims a priority of Chinese patent application No. 201510149687.X filed on Mar. 31, 2015, the disclosure of which is incorporated herein by reference in its entirety.

### TECHNICAL FIELD

The present disclosure relates the technical field of manufacturing displays, and in particular to a light sources device and an alignment mark shooting and recognizing system.

### BACKGROUND

Upon forming array, color filter, cell alignment and module during manufacture of a liquid crystal display (LCD) panel, a position of a substrate has to be aligned and adjusted before arranging the substrate to ensure processing precision, because it is unable to precisely arrange the substrate at a preferable position during transporting, clamping and processing of the substrate. The precision of the substrate alignment directly affects the quality of the LCD products. Thus, it is necessary for the precision of the alignment system to be extremely high to implement the alignment process. Nowadays, a trend in the LCD field is to develop premium products, and high pixel per inch (ppi) and high precision products are a direction of future market needs. The alignment precision directly affects the product quality, and thus the rapid development of the alignment technology is an important guarantee of improving the product quality.

FIG. 1 illustrates a traditional alignment mark shooting and recognizing system for the substrate, including a camera 103, an alignment adjusting ruler 101 and an adjusting knob 102 for adjusting a focal length of the camera 103, a light source box 105, and a support frame 104 for supporting the camera 103 and the light source box 105. The light box 105 is arranged between the substrate 108 to be aligned and the camera 103, and a light emitted by the light source box 105 is transmitted to the substrate 108 and an alignment mark 106 engraved in the substrate 108.

FIG. 2 illustrates a partial schematic view of the traditional light source box 105 and light paths. The light source box 105 includes a case, a light source arranged at one side of the case (not shown), and a glass panel 201 for reflecting and transmitting light. The glass panel 201 is located in the case of the light box 105 and tilted at 45 degrees, and the incident light 202 emitted by the light source arranged at one side of the case is transmitted to and reflected by the glass panel 201 to generate a first reflected light 203, which is transmitted to the alignment mark 106 and reflected by the substrate 108 to generate a second reflected light 204. Then, the second reflected light is transmitted to the camera 103 which is located above the light source box, and thus the camera 103 receives the light reflected by the alignment mark 106, so as to capture a position and a shape of alignment mark.

In the above method, the light emitted by the light source located at one side of the case is incident to and reflected by the intermediate transparent glass panel to irradiate the alignment mark, a luminance of the light arriving at the mark 106 is low, a contrast of the mark captured by the camera is weak, and a phenomenon that the camera can capture the mark on a thin film transistor (TFT) array substrate while cannot capture the mark on a color filter (CF) substrate may occur, because background colors of the marks and contrasts caused by the light irradiation on the TFT substrate and the CF substrate are different.

### SUMMARY

An object of the present disclosure is to provide a light source device and an alignment mark shooting and recognizing system for increasing the light luminance upon shooting and recognizing for the substrate alignment, so that the capability of the camera for recognizing for the substrate alignment can be enhanced, and the alignment precision is improved.

The present disclosure provides a light source device, including: a case, defining an accommodation space and including a light transmissible surface and a locating-mounting hole, the locating-mounting hole defining a projection through space within the accommodation space in an axial direction of the locating-mounting hole; and a plurality of light emitting sources, arranged within the accommodation space, surrounding the projection through space and configured for emitting light towards the light transmissible surface.

Further, in the above light source device, the case further includes a first surface arranged opposite to the light transmissible surface; the locating-mounting hole is arranged in the first surface; and the projection through space is a space region extending from the locating-mounting hole in the first surface to the light transmissible surface in the axial direction of the locating-mounting hole.

Further, in the above light source device, the case further includes a first surface arranged opposite to the light transmissible surface; the locating-mounting hole extends through both the light transmissible surface and the first surface; and the projection through space is a space region of the locating-mounting hole extending between the light transmissible surface and the first surface in the axial direction of the locating-mounting hole.

Further, in the above light source device, the light transmissible surface is parallel to the first surface.

Further, in the above light source device, the light source device further includes a light source mounting plate on which the light emitting sources are arranged; wherein the light source mounting plate is of a curved shape with a center located at a side where the light transmissible surface is arranged; and the light emitting sources are arranged according to a radian of the curved shape of the light source mounting plate.

Further, in the above light source device, the accommodation space has an inner surface of a curved shape; the light source mounting plate is arranged on the inner surface of the accommodation space according to the curved shape of the inner surface of the accommodation space.

Further, in the above light source device, the light source device further includes a reflection plate arranged on a side of the light source mounting plate facing the center; wherein the reflection plate is arranged according to the radian of the curved shape of the light source mounting plate in such a manner that the light emitted by the light emitting sources are reflected towards the light transmissible surface.

Further, in the above light source device, the center of the curved shape defined by the light source mounting plate is located at a side of the light transmissible surface away from the light sources.

Further, in the above light source device, the light source device further includes a light diffusion plate arranged on the light transmissible surface and configured for transmitting the light evenly.

Further, in the above light source device, the light emitting sources include a plurality of columns of light emitting diodes (LEDs) which are disposed around the projection through space evenly; and the LEDs in each column are arranged in a line perpendicular to the axial direction of the locating-mounting hole and in a direction from a position being close to the projection through space to a position being far from the projection through space.

The present disclosure further provides an alignment mark shooting and recognizing system, including: a camera configured to shoot an alignment mark on a substrate, and any one of the above light source device; wherein the light source device is mounted on the camera via the locating-mounting hole.

Further, in the above alignment mark shooting and recognizing system, the above alignment mark shooting and recognizing system further includes: an adjusting knob configured for adjusting a focal length of the camera; and an adjusting ruler configured for aligning the focal length.

Further, the light emitting sources in the light source device surround the camera.

Further, the camera is inserted into the locating-mounting hole, and a shooting end of the camera is located within the accommodation space of the light source device.

Further, the camera is inserted into the locating-mounting hole and extends through the light source device, and a shooting end of the camera is located outside the accommodation space of the light source device.

The following beneficial effects may be obtained by at least one of the above technical solutions provided by the embodiments of the present disclosure.

The light source device is arranged to be a ring-shaped light source. When such light source device is adopted in the substrate alignment mark shooting and recognizing system, the light emitted by the light sources may directly irradiate the mark on the substrate. Comparing with the light source device in prior art, the light arriving at the position of the mark on the substrate is stronger, and thus the luminance of the light for shooting and recognizing for the substrate alignment is increased. As a result, the capability of the camera for recognizing for the substrate alignment can be enhanced, and the alignment precision is improved.

### BRIEF DESCRIPTION OF THE DRAWINGS

FIG. 1 is a three dimensional view of a substrate alignment mark shooting and recognizing system in prior art:

FIG. 2 illustrates light paths in a light source box in prior art:

FIG. 3 illustrates a side perspective view of arrangements of a light source device and a camera according to a first embodiment of the present disclosure:

FIG. 4 illustrates a top view of the light source device according to the first embodiment of the present disclosure;

FIG. 5 illustrates a side perspective view of arrangements of a light source device and a camera according to a second embodiment of the present disclosure; and

FIG. 6 is a perspective view of a portion of an alignment mark shooting and recognizing system according to one embodiment of the present disclosure.

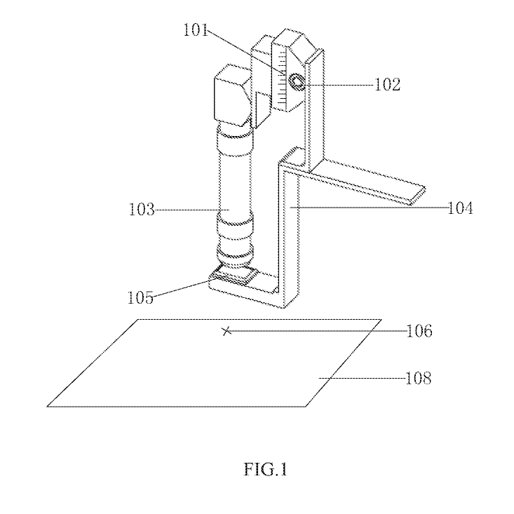

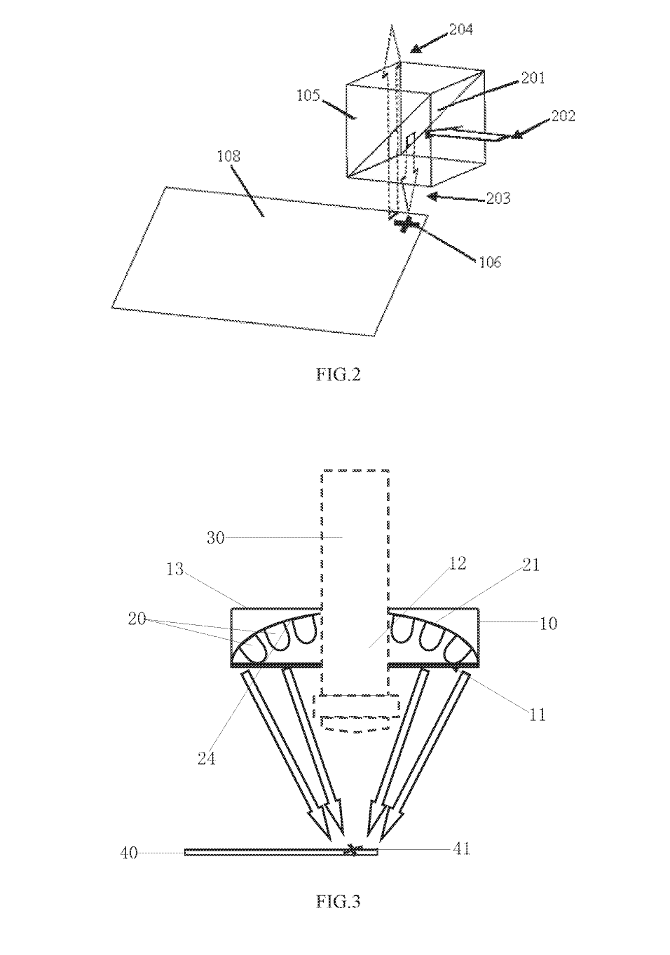

### DETAILED DESCRIPTION

Hereinafter, it will be discussed in details associated with figures and embodiments for further clarifying objects, technical solutions and advantages of the present disclosure.

In one embodiment of the present disclosure, a light source device includes:

a case, defining an accommodation space and including a light transmissible surface and a locating-mounting hole, and the locating-mounting hole defining a projection through space within the accommodation space in an axial direction of the locating-mounting hole; and

a plurality of light emitting sources, arranged within the accommodation space and surrounding the projection through space, the light emitting sources being configured for emitting light towards the light transmissible surface.

In this embodiment, the light sources surround the projection through space within the accommodation space of the case and define a ring-shaped light source. When such light source device is adopted in the substrate alignment mark shooting and recognizing system, the camera can be inserted into the projection through space through the locating-mounting hole, so that the light sources are disposed around the camera. The light emitted by the light sources may directly irradiate the mark on the substrate. Comparing with the light source device in prior art, the light arriving at the position of the mark on the substrate is stronger, and thus the luminance of the light for shooting and recognizing for the substrate alignment is increased. As a result, the capability of the camera for recognizing for the substrate alignment can be enhanced, and the alignment precision is improved.

FIG. 3 illustrates a side view of arrangements of a light source device and a camera according to a first embodiment of the present disclosure. As illustrated in FIG. 3, in this embodiment, the light source device includes: a case 10 defining an accommodation space for accommodating light sources 20. The case 10 includes a light transmissible surface 11. The light emitted by the light sources 20 may transmits through the light transmissible surface 11. The case 10 further includes a locating-mounting hole 12 defined therein.

In this embodiment, the case 10 includes a first surface 13 arranged opposite to the light transmissible surface 11; and the locating-mounting hole 12 is extended through both the first surface 13 and the light transmissible surface 11, as illustrated in FIG. 3. In the above arrangement, a space, i.e. the projection through space, is defined by the locating-mounting hole 12 extending between the first surface 13 and the light transmissible surface 11 in the axial direction of the locating-mounting hole within the accommodation space of the case 10. Preferably, the locating-mounting hole 12 is arranged to be at a center of the case 10.

As illustrated in FIG. 3, when the above light source device is mounted in the substrate alignment shooting and recognizing system, the light transmissible surface 11 is located at a bottom surface of the case 10, and the first surface 13 is located at a top surface of the case 10. The camera 30 of the substrate alignment shooting and recognizing system may be inserted in a direction from the first surface 13 of the case 10 to the light transmissible surface 11, and then emerges from the light transmissible surface 11 after extending through the whole projection through space. Thus, the case 10 of the light source device is sleeved to the camera 30, the light transmissible surface 11 is arranged opposite to the substrate 40 to be aligned, and the camera 30 is located at a position over the mark 41 on the substrate 40 to be aligned for capturing an image of the mark 41. The light sources 20 within the light source device surround the camera 30 and emit light towards the light transmissible surface 11, respectively. Thus, the light emitted by the light sources 20 may directly irradiate the mark 41 on the substrate 40 to be aligned after transmitting through the light transmissible surface 11. Furthermore, since the light sources 20 surround the camera 30, the positions in all directions of 360 degrees around the camera 30 can be irradiated, and any dark corner is prevented. In contrast to light sources in the prior art, the light emitted by the above light sources may directly irradiate the mark on the substrate, and thus the light sources may not shield a region to be shot by the camera. Moreover, the light arriving at the position of the mark on the substrate is stronger, and thus the luminance of the light for shooting and recognizing for the substrate alignment is increased. As a result, the capability of the camera for recognizing for the substrate alignment can be enhanced.

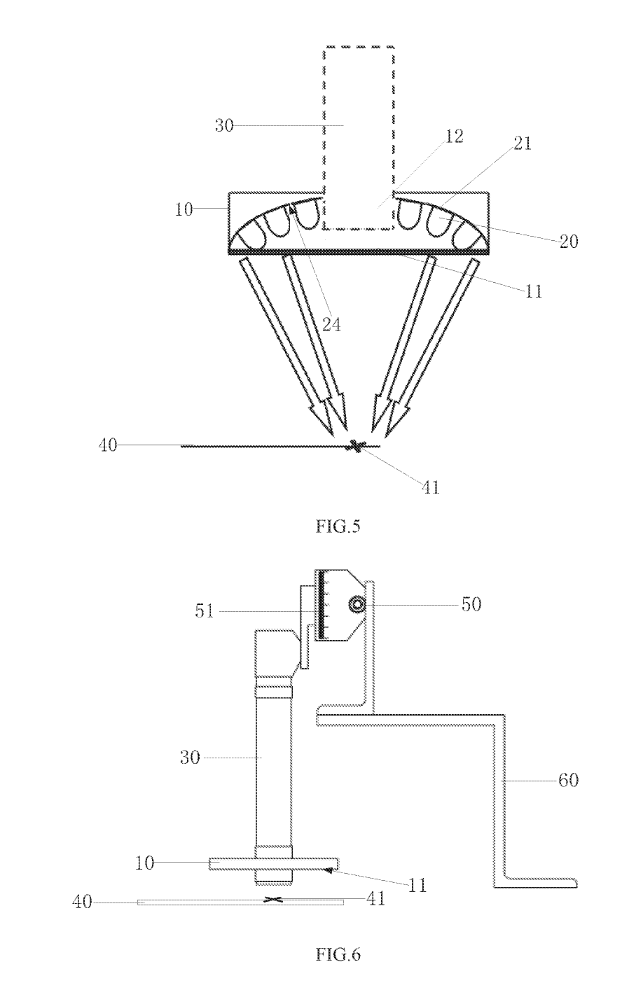

Preferably, in the first embodiment, the light transmissible surface 11 is opposite to and parallel with the first surface 13 as illustrated in FIG. 3. Thus, the light source device is formed to be a box structure of a cylinder shape as illustrated by the perspective view in FIG. 6.

Furthermore, as illustrated in FIG. 3, the light source device further includes a light source mounting plate 21 on which the light emitting sources 20 are arranged. The light source mounting plate 21 is of a curved shape, a center of the curved shape is located at a side where the light transmissible surface 11 is arranged, and the light emitting sources 20 are arranged based on a radian of the curved shape of the light source mounting plate 21. With such curved shape arrangement, the light emitted by all of the light sources 20 is transmitted to the position of the mark 41 on the substrate 40 to facilitate the convergence of the light, and thus most of the light may irradiate the mark 41. Furthermore, preferably, a reflection plate 24 is arranged on a side of the light source mounting plate 21 facing the center of the curved shape, i.e. the side where the light sources 20 are arranged. The reflection plate 21 is attached at the surface of the side of the light source mounting plate 21 based on the radian of the curved shape of the light source mounting plate 21, so that the light emitted by the light emitting sources 20 is reflected in a direction towards the light transmissible surface 11, which facilitates the irradiation of the mark 41 on the substrate 40 by the light sources 20.

Furthermore, an inner surface of the accommodation space of the case 10 may be formed of being in a curved shape, and the light source mounting plate 21 is arranged on the inner surface of the accommodation space based on the curved shape of the inner surface of the accommodation space. Alternatively, the inner surface of the accommodation space of the case 10 may be directly arranged to be the light source mounting plate 21 of being in the curved shape, and thus the light sources 20 may be directly arranged on the inner surface of the accommodation space of the case 10. Furthermore, a light diffusion plate is arranged on the light transmissible surface 11, so as to ensure that the light transmitted through the light transmissible surface 11 may irradiate the mark 41 on the substrate 40 more evenly.

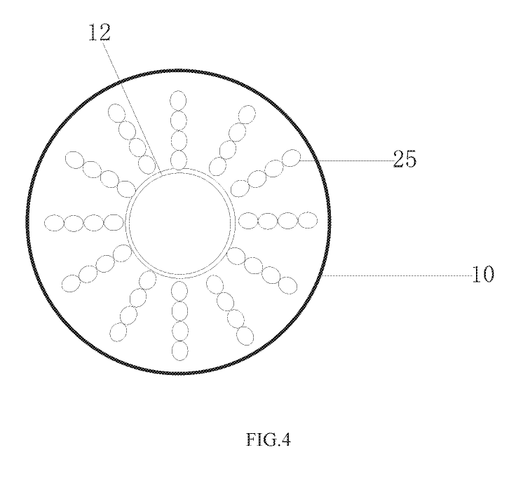

As illustrated in FIG. 4, in this embodiment, the light emitting sources 20 include a plurality of columns of light emitting diodes (LEDs) 25 which are evenly disposed at positions surrounding the projection through space where the camera is arranged, and the LEDs in each column are arranged in a line perpendicular to the axial direction of the locating-mounting hole 12 and in a direction from a position being close to the projection through space to a position being far from the projection through space. As a result, as illustrated in FIG. 4, a plurality of columns of LED light resources are arranged around the locating-mounting hole 12 in radial directions, so that the light sources are disposed around the camera 30 evenly.

In a second embodiment, the present disclosure provides a light source device, a side perspective view of which is illustrated in FIG. 5. Similar to the light source device in the first embodiment, the light source device in the second embodiment includes a case 10 defining an accommodation space for accommodating light sources 20. The case 10 includes a light transmissible surface 11 through which the light emitted by the light sources 20 may transmit. The case 10 further includes a locating-mounting hole 12 defined therein.

Different from the first embodiment, in the second embodiment, the locating-mounting hole 12 is arranged in the first surface 13 opposite to the light transmissible surface 11. The projection through space is a space region extending from the locating-mounting hole 12 in the first surface 13 to the light transmissible surface 11 along the axial direction of the locating-mounting hole 12. As illustrated in FIG. 5, when the above light source device is mounted in the substrate alignment shooting and recognizing system, the camera 30 may be inserted in a direction from the first surface 13 of the case 10 to the light transmissible surface 11, but a shooting end of the camera 30 may not emerge from the light transmissible surface 11 and remains within the case 10. Thus, the light source device is sleeved at the shooting end of the camera 30.

In the second embodiment, the light transmissible surface 11 is arranged opposite to the substrate 40 to be aligned, and the camera 30 is located above the light transmissible surface 11 and the mark 41 on the substrate 40 to be aligned for capturing an image of the mark 41 through the light transmissible surface 11. The light sources 20 within the light source device surround the camera 30, and emit light towards the light transmissible surface 11, respectively. Thus, the light emitted by the light sources 20 may transmit through the light transmissible surface 11 and then directly irradiate the mark 41 on the substrate 40 to be aligned. Furthermore, since the light sources 20 surround the camera 30, thus the positions in all directions of 360 degrees around the camera 30 can be irradiated, and any dark corner is prevented. Thus, similarly as being in the first embodiment, the light source device in the second embodiment may also improve the luminance of the light for shooting and recognizing for the substrate alignment, so that the capability of the camera for recognizing for the substrate alignment can be enhanced.

As a matter of fact, in the light source device of the second embodiment, the camera 30 captures an image through the light transmissible surface 11 and thus the light source device of the first embodiment is preferred for securing the clarity of the captured image.

Furthermore, similarly as being in the first embodiment, the light source device in the second embodiment further includes the light source mounting plate 21 on which the light emitting sources 20 are arranged. The light source mounting plate 21 is of a curved shape. A reflection plate 24 is arranged on a side of the light source mounting plate 21 where the light sources 20 are arranged. Optionally, a light diffusion plate is further arranged on the light transmissible surface 11. Furthermore, in this embodiment, the arrangement of the light sources 20 may be similar as that in the first embodiment, and thus a description thereof is not omitted herein for clarity.

One embodiment of the present disclosure further provides an alignment mark shooting and recognizing system which is used for aligning substrates when manufacturing display devices. The alignment mark shooting and recognizing system includes a camera configured to shoot an alignment mark on a substrate, and the light source device as described above. The light source device is mounted on the camera via the locating-mounting hole, and the camera obtains a position of the alignment mark via shooting the alignment mark through the projection through space and the light transmissible surface.

FIG. 6 illustrates a perspective view of the alignment mark shooting and recognizing system according to one embodiment of the present disclosure. The alignment mark shooting and recognizing system includes: a camera 30, an adjusting knob 50 configured for adjusting a focal length of the camera 30, an adjusting ruler 51 configured for aligning the focal length, a light resource device 10, and a supporting frame 60 for supporting the camera 30. The camera 30 is extended through the case of the light source device 10, and emerges from the light transmissible surface of the light source device 10. The light transmissible surface 11 is opposite to the substrate 40 to be aligned, and the camera 30 is arranged above the mark 41 on the substrate 40 to be aligned for capturing the image of the mark 41. The light sources 20 within the light source device surround the camera 30, and emit the light towards the light transmissible surface 11, respectively.

In this embodiment, the arrangement of the light source device in the alignment mark shooting and recognizing system is similar to that in the above embodiments, and thus a description thereof is not omitted herein for clarity.

In this embodiment, the alignment mark shooting and recognizing system including the light source device may enhance the capability of the camera for recognizing for the substrate alignment.

The above are merely the preferred embodiments of the present disclosure and shall not be used to limit the scope of the present disclosure. It should be noted that, a person skilled in the art may make improvements and modifications without departing from the principle of the present disclosure, and these improvements and modifications shall also fall within the scope of the present disclosure.

1. A light source device comprising:
a case, defining an accommodation space and comprising a light transmissible surface and a locating-mounting hole, the locating-mounting hole defining a projection through space within the accommodation space in an axial direction of the locating-mounting hole; and
a plurality of light emitting sources, arranged within the accommodation space, surrounding the projection through space and configured for emitting light towards the light transmissible surface.

2. The light source device according to claim 1, wherein the case further comprises a first surface arranged opposite to the light transmissible surface; the locating-mounting hole is arranged in the first surface; and the projection through space is a space region extending from the locating-mounting hole in the first surface to the light transmissible surface in the axial direction of the locating-mounting hole.

3. The light source device according to claim 1, wherein the case further comprises a first surface arranged opposite to the light transmissible surface; the locating-mounting hole extends through both the light transmissible surface and the first surface; and the projection through space is a space region of the locating-mounting hole extending between the light transmissible surface and the first surface in the axial direction of the locating-mounting hole.

4. The light source device according to claim 2, wherein the light transmissible surface is parallel to the first surface.

5. The light source device according to claim 1, further comprising a light source mounting plate on which the light emitting sources are arranged; wherein the light source mounting plate is of a curved shape with a center located at a side where the light transmissible surface is arranged; and the light emitting sources are arranged according to a radian of the curved shape of the light source mounting plate.

6. The light source device according to claim 5, wherein the accommodation space has an inner surface of a curved shape; the light source mounting plate is arranged on the inner surface of the accommodation space according to the curved shape of the inner surface of the accommodation space.

7. The light source device according to claim 5, further comprising a reflection plate arranged on a side of the light source mounting plate facing the center; wherein the reflection plate is arranged according to the radian of the curved shape of the light source mounting plate in such a manner that the light emitted by the light emitting sources are reflected towards the light transmissible surface.

8. The light source device according to claim 5, wherein the center of the curved shape defined by the light source mounting plate is located at a side of the light transmissible surface away from the light sources.

9. The light source device according to claim 1, further comprising a light diffusion plate arranged on the light transmissible surface and configured for transmitting the light evenly.

10. The light source device according to claim 1, wherein the light emitting sources comprise a plurality of columns of light emitting diodes (LEDs) which are disposed around the projection through space evenly; and the LEDs in each column are arranged in a line perpendicular to the axial direction of the locating-mounting hole and in a direction from a position being close to the projection through space to a position being far from the projection through space.

11. An alignment mark shooting and recognizing system, comprising: a camera configured to shoot an alignment mark on a substrate, and a light source device;
wherein the light source device comprises:
a case, defining an accommodation space and comprising a light transmissible surface and a locating-mounting hole, the locating-mounting hole defining a projection through space within the accommodation space in an axial direction of the locating-mounting hole; and
a plurality of light emitting sources, arranged within the accommodation space, surrounding the projection through space and configured for emitting light towards the light transmissible surface:
wherein the light source device is mounted on the camera via the locating-mounting hole.

12. The alignment mark shooting and recognizing system according to claim 11, further comprising: an adjusting knob configured for adjusting a focal length of the camera, and an adjusting ruler configured for aligning the focal length.

13. The alignment mark shooting and recognizing system according to claim 11, wherein the light emitting sources in the light source device surround the camera.

14. The alignment mark shooting and recognizing system according to claim 13, wherein the camera is inserted into the locating-mounting hole, and a shooting end of the camera is located within the accommodation space of the light source device.

15. The alignment mark shooting and recognizing system according to claim 13, wherein the camera is inserted into the locating-mounting hole and extends through the light source device, and a shooting end of the camera is located outside the accommodation space of the light source device.

16. The alignment mark shooting and recognizing system according to claim 11, wherein the case further comprises a first surface arranged opposite to the light transmissible surface; the locating-mounting hole is arranged in the first surface; and the projection through space is a space region extending from the locating-mounting hole in the first surface to the light transmissible surface in the axial direction of the locating-mounting hole.

17. The alignment mark shooting and recognizing system according to claim 11, wherein the case further comprises a first surface arranged opposite to the light transmissible surface; the locating-mounting hole extends through both the light transmissible surface and the first surface; and the projection through space is a space region of the locating-mounting hole extending between the light transmissible surface and the first surface in the axial direction of the locating-mounting hole.

18. The alignment mark shooting and recognizing system according to claim 11, wherein the light source device further comprises a light diffusion plate arranged on the light transmissible surface and configured for transmitting the light evenly.

19. The alignment mark shooting and recognizing system according to claim 11, wherein the light emitting sources comprise a plurality of columns of light emitting diodes (LEDs) which are disposed around the projection through space evenly; and the LEDs in each column are arranged in a line perpendicular to the axial direction of the locating-mounting hole and in a direction from a position being close to the projection through space to a position being far from the projection through space.
